(19) United States
(12) Patent Application Publication
(10) Pub. No.: US 2006/0061685 A1
(43) Pub. Date: Mar. 23, 2006

(54) Receiver comprising multiple parallel reception means

(75) Inventor: Alexandre Humbersot, Rennes (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/522,465

(22) PCT Filed: Jul. 11, 2003
(86) PCT No.: PCT/IB03/03191

§ 371 Date: Jan. 26, 2005

(30) Foreign Application Priority Data
Jul. 31, 2002 (FR) 02/09744

(51) Int. Cl. H04N 5/04; H04N 9/44

(52) U.S. Cl. 348/501

(57) ABSTRACT

The invention relates to a receiver for receiving an analog signal having a spectrum situated in a given frequency band higher than the baseband. It comprises reception means which manage at least one narrow-band noise signal located around a given noise frequency. The receiver comprises a plurality of parallel baseband conversion means defining a plurality of reception channels for converting the spectrum of the received signal in reception bands close to the baseband and shifted with respect to one another so that, on each reception band, the narrow-band noise is superimposed on the shifted spectrum of the received signal at distinct points relative to said spectrum. It also comprises recombination means for recombining the many shifted spectra of die received signal obtained on each reception channel and for obtaining a single spectrum corresponding to the spectrum of the received signal with the effect of the narrow-band noise removed and situated in a frequency band close to the baseband.

### FIELD OF THE INVENTION

The invention relates to the field of signal transmissions. More particularly, it relates to a device for receiving an analog signal having a spectrum situated in a given frequency band higher than a reference band centered around zero, referred to as the baseband, and comprising reception means which manage at least one narrow-band noise signal located around a given noise frequency.

The invention also relates to a digital television receiver and a multimedia receiver containing such a device as well as a transmission system.

It also relates to a reception method and a program comprising instructions for implementing said reception method.

The invention applies to all analog and digital transmissions but is particularly advantageous in the case of broad-band transmissions such as video transmissions or more generally multimedia transmissions. It also applies to cellular radio communications which require transmitting a large volume of data at the same time.

### BACKGROUND OF THE INVENTION

Receivers for the general public generally use inexpensive components, which can be produced for example according to RFCMOS (Radio Frequency Complementary Metal-Oxide-Silicon) technology. These receivers generate a not insignificant narrow-band noise signal proportional to 1/f around a given frequency, in general, but not necessarily, the zero or DC frequency. At the time of the conversion, referred to as baseband conversion, which is carried out in the receiver, the spectrum of the analog signal received is converted into a frequency band appreciably lower than the carrier frequency of the signal transmitted in order to be able to process the signal received. The noise signal in 1/f has a tendency to interfere with the spectrum of the signal received since it is situated in the reception frequency band after conversion. There exist techniques for reducing the effect of this noise in 1/f by appropriately choosing the analog components used in the receiver. One of these techniques is described in the U.S. patent published under the U.S. Pat. No. 6,160,274. It can be relatively expensive and complex to implement, which is not desirable for producing receivers for the general public.

It is an object of the invention to remedy this drawback.

### SUMMARY OF THE INVENTION

This object is achieved with a device as mentioned in the introductory paragraph, comprising a plurality of parallel baseband conversion means introducing a plurality of reception channels in order to convert the spectrum of the signal received into reception bands close to the baseband and shifted relative to one another so that, on each reception band, the narrow-band noise is superimposed on the shifted spectrum of the signal received at distinct points relative to said spectrum and recombination means for recombining the many shifted spectra of the signal received on each reception channel and obtaining a single spectrum corresponding to the spectrum of the signal received with the effect of the narrow-band noise removed.

The use of several reception channels makes it possible, after conversion of the signal received in judiciously chosen different given frequency bands, to obtain several shifted spectra of the signal received affected by the narrow-band noise at distinct points. Ideally, for each relative frequency of the spectrum, there exists at least one spectrum for which this relative frequency is not affected by the narrow-band noise. It is thus possible to reconstruct the spectrum of the signal received with the narrow-band noise removed by eliminating parts of the spectrum affected by the narrow-band noise and replacing them with non-affected parts coming from other shifted spectra of the signal received.

Advantageously, this technique makes it possible to preserve the spectrum of the signal received in frequency bands close to the baseband, which makes it possible to use relatively low sampling frequencies for processing the signal in a receiver.

According to a preferred embodiment of the invention, the baseband conversion means are designed to shift the spectrum of the signal received symmetrically with respect to the zero frequency. This also makes it possible to use the same sampling frequency on each reception channel, which is practical from the point of view of implementation in the receiver.

### BRIEF DESCRIPTION OF THE DRAWINGS

The invention will be further described with reference to examples of embodiments shown in the drawings to which, however, the invention is not restricted.

FIG. 1 is a functional schematic representation of an example of a first part of a device according to the invention,

FIG. 2A is a functional schematic representation of an example of a second part of a device according to a first embodiment of the invention,

FIG. 2B is a set of graphs for illustrating the change in the spectrum of the signal received as it is processed by the device of FIG. 2A,

FIG. 3A is a functional schematic representation of an example of the second part of a device according to a second embodiment of the invention,

FIG. 3B is a set of graphs for illustrating the change in the spectrum of the signal received as it is processed by the device of FIG. 3A,

FIG. 4 is a functional schematic representation of an example of the second part of a device according to a third embodiment of the invention,

FIG. 5 is a functional schematic representation of an example of a transmission system comprising a receiver according to the invention.

### DESCRIPTION OF PREFERRED EMBODIMENTS

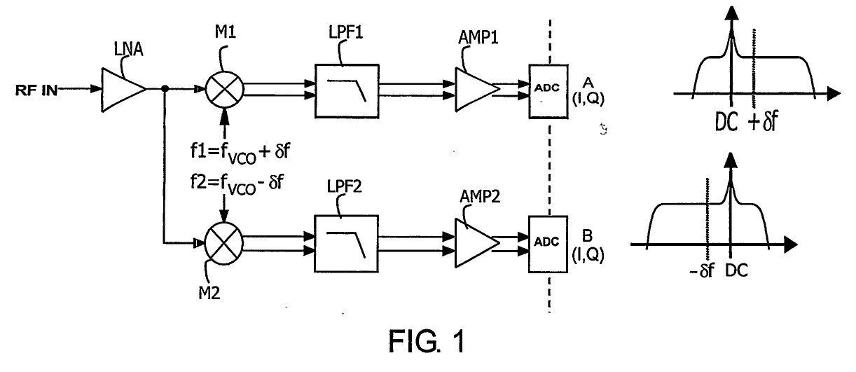

FIG. 1 shows schematically an example of embodiment of the analog part of a receiver according to the invention. This may be any receiver of electrical signals such as radar or a wireless connector receiving Bluetooth signals, a digital television receiver compatible with the DVB-S (Digital Video Broadcasting—Satellite) standard, a mobile radio receiver according to the GSM (Global System for Mobile communications) or UMTS (Universal Mobile Telecommunication System) standard etc.

In the remainder of the description, the example has been considered of RFCMOS technology, which introduces a narrow-band noise in 1/f centered on the zero frequency. The same reasoning can be applied to any type of narrow-band noise.

The invention relates more particularly to low-cost receivers using low-performance technologies. One means of producing inexpensive digital receivers is to integrate the analog part and the digital part of the receiver in a single component designed using RFCMOS technology for example. This technology, designed initially to produce the digital part of the receiver, is of low performance with regard to the analog components. Analog components produced with this technology in reception mode in general introduce a narrow-band noise in 1/f situated at a known frequency, f representing the frequency of the signal received, which is somewhat of a nuisance for the remainder of the processing of the signal. This is because this noise in 1/f is located in the band of the signal received for conversion into baseband. During this conversion, part of the useful signal may therefore be lost. Shifting the signal reception band towards the high frequencies in order to avoid the area affected by the noise merely moves the problem to another level since, in this case, it is the sampling frequency which will have to be higher according to the known Shannon principle. The cost of producing the digital part of the receiver will be increased thereby, especially if the signal received has a broad spectrum, which is the case in particular in satellite transmissions or multimedia transmissions in general.

The solution recommended by the invention consists of providing several reception channels in the receiver for converting the signal received into several frequency bands close to the baseband but shifted with respect to one another so that the signal received is altered by the noise in 1/f at different points in its spectrum, making it possible at the end of the chain to reconstruct a complete signal unaffected by the noise. Since the receiver may introduce other narrow-band noises not centered on the zero frequency, it may comprise a number of reception channels greater than two.

The analog part of the receiver illustrated in FIG. 1 comprises a plurality of baseband conversion means arranged in parallel, which define a plurality of (here only two) reception channels, in order to convert the spectrum of the signal received into reception bands close to the baseband and shifted with respect to one another so that, on each reception band, the noise in 1/f is superimposed on the shifted spectrum of the signal received at distinct points relative to said spectrum.

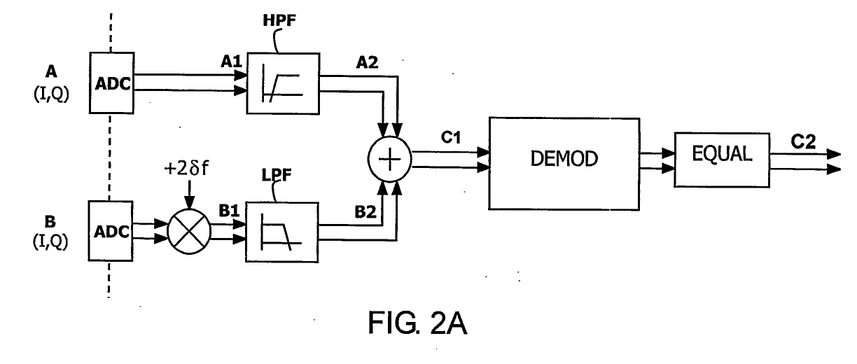

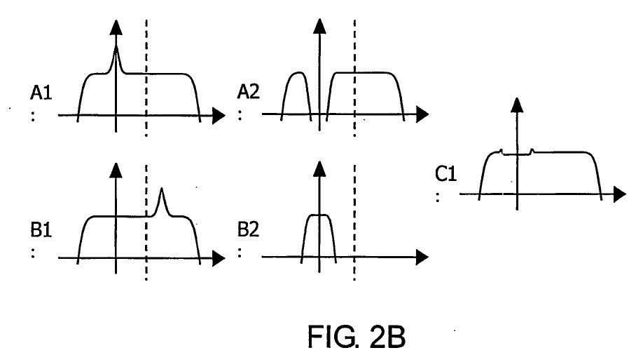

FIG. 1 also shows other implementation details. RF IN represents the analog signal received for example from an antenna. It is amplified by a low-noise amplifier LNA, which increases the level of the signal received. Each reception channel or branch comprises a mixer M1, M2 for mixing the signal received with a signal at a predetermined frequency f1, f2, in order to convert the signal received into a frequency band centered around the predetermined frequency. Use will preferably be made of frequencies f1 and f2 shifted symmetrically with respect to a fixed frequency, for example the frequency of a voltage-controlled oscillator, denoted f_{VCO}, so that the maximum frequencies in absolute value of each spectrum centered around f1=f_{VCO}+δf and f2=f_{VCO}−δf, respectively, are identical. This will make it possible, in the remainder of the processing, to use the same sampling frequency for each reception channel. A low-pass or passband filter LPF1, LPF2, depending on whether or not the spectrum is centered around zero, cuts the useful signal at high frequencies or around the band of the useful signal, respectively. An amplifier AMP1, AMP2 is necessary for amplifying the signal, which has lost part of its energy during the filtering, and for optimizing the use of the analog to digital converter ADC placed at the output of each amplifier AMP1, AMP2. This is because the signal at the input of the converter ADC must be powerful enough to use the entire amplitude of the converter and afford effective digitization. At the output of the mixers Md1, M2, the signal supplied is a complex quadrature signal, denoted (I,Q), shown on two distinct wires. The shifted spectrum of the signal supplied at the output of each converter ADC is shown alongside each converter ADC. It is centered on each reception frequency δf and −δf, corresponding to each reception channel, respectively. It has been assumed in the example illustrated in FIG. 1 that the noise in 1/f is centered on zero. Each spectrum, centered around its reception frequency δf or −δf, respectively, is altered around zero (DC) at different relative points on the spectrum. It is therefore possible to reconstruct a single spectrum not affected by the noise from two shifted spectra obtained at the output of the converters ADC. Several recombination methods can be envisaged. FIGS. 2 to 4 illustrate three possible recombination methods amongst others.

FIG. 2A illustrates the part devoted to the digital processing of a digital receiver, whose analog part is illustrated in FIG. 1, according to a first embodiment of the invention. It comprises the two converters ADC in parallel, one on each reception channel, which mark the passage between the analog processing illustrated in FIG. 1 and the digital processing which follows. In the example illustrated in FIG. 2A, the spectra issuing from the two distinct channels are recombined as a single spectrum by means of a partial addition of the two spectra. This partial addition is carried out by the following means. On one of the two channels, here channel A, high-pass filtering means HPF filter the signal received in a first frequency band around the noise frequency in 1/f, here for example the zero frequency (DC). On the other channel, here channel B, shifting means, represented by a mixer, shift the spectrum of the signal received by the difference, here equal to +2 δf, between the first and second reception frequencies, here δf and −δf, and filtering means LPF complementary to the filtering means HPF of channel A filter the signal received outside a second frequency band centered around said noise frequency in 1/f, including the first frequency band filtered by channel A. Addition means, represented by an adder, add the signals coming from the first and second reception channels A and B. At the output of the adder, the normal digital processing of the receiver continues with the demodulation DEMOD, the equalization EQUAL and the channel and source decoding, not shown in the figure. The role of the equalizer EQUAL is to correct downstream any degradations in the signal due to imperfections introduced by the preceding processing, in particular the imperfect complementarity of the filters HPF and LPF, the possible difference in gain between the two channels or the imperfection of the control of the frequency shift δf.

FIG. 2B shows the spectrum curves of the signal during the various steps of the digital processing, at points A1, A2, B1, B2 and C1.

This embodiment is suitable when the noise in 1/f of the receiver is located on a single noise frequency.

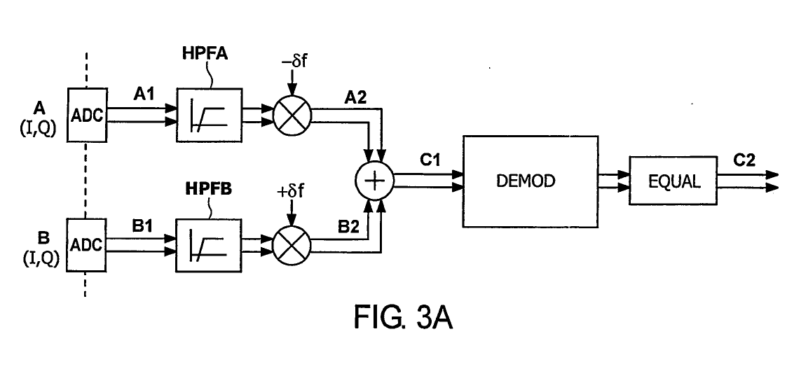

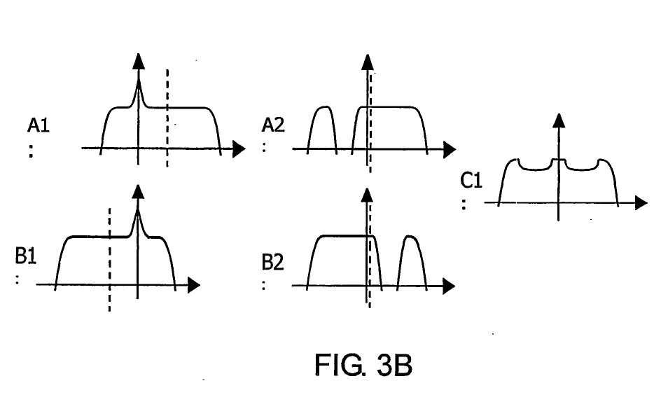

FIG. 3A illustrates the part devoted to the digital processing of a digital receiver, whose analog part is illustrated in FIG. 1, according to a second embodiment of the invention. It comprises the two ADC converters in parallel, one on each reception channel A and B, which mark the passage between the analog processing illustrated in FIG. 1 and the digital processing which follows. In the example illustrated in FIG. 3A, the spectra coming from the two distinct channels are recombined as a single spectrum by means of a so-called complete addition of the two spectra. This complete addition is carried out by the following means. On each channel, filtering means HPFA or HPFB, respectively, filter the signal received in a first frequency band around the noise frequency in 1/f, here for example the zero frequency (DC). Shifting means, represented by mixers, shift the spectrum of the filtered signal by the inverse of the difference δf or −δf applied to the channel in question by the mixer M1 or M2, respectively, during the analog processing illustrated in FIG. 1: that is to say −δf for channel A and +δf for channel B. Addition means, represented by an adder, add the signals coming from said first and second reception channels. At the output of the adder, the digital processing is equivalent to that carried out according to the first embodiment illustrated in FIG. 2A.

FIG. 3B shows the spectrum curves of the signal during the various steps of the digital processing, at points A1, A2, B1, B2 and C1.

This embodiment is adapted when the phase difference between the two channels, due to the estimation of δf, remains below π (pi). If the two channels are in phase opposition, the recombination of the two signals will result in a destructive addition.

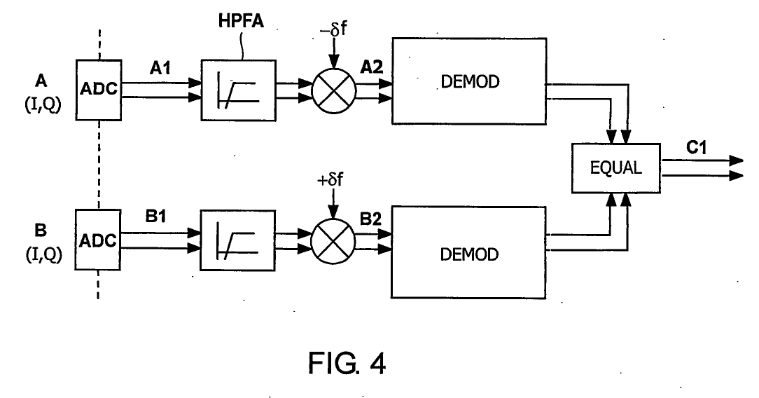

FIG. 4 illustrates the part devoted to digital processing of a digital receiver according to a third embodiment of the invention. In the example illustrated in FIG. 4, the spectra coming from the two distinct channels are recombined as a single spectrum by means of an equalizer. The means used in this embodiment are identical to those used in the embodiment illustrated in FIG. 3A as far as the output of the two mixers. Next, the standard digital processing of the receiver is carried out in parallel on each channel. The two signals are then added in the equalizer EQUAL in order to continue the processing of the receiver as far as decoding.

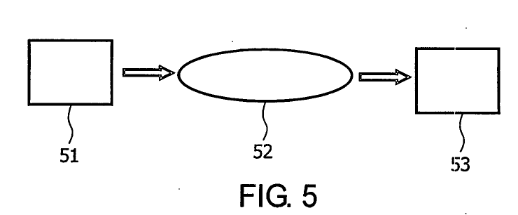

FIG. 5 depicts an example of a transmission system according to the invention which comprises an emitter 51 for emitting electrical signals, a transmission medium 52 for transmitting the said signals and a receiver 53 for receiving them. The receiver 53 is for example of the digital television receiver type according to the DVB-S standard or a mobile radio receiver according to the GSM or UMTS standard comprising a device as described previously with regard to FIGS. 1 to 4.

In practice, at least the digital part of the invention can be implemented using software means. For this purpose, a device according to the invention comprises one or more processors and one or more program storage memories, the programs containing instructions for implementing the functions which have just been described, when they are executed by said processors.

The drawings and the description thereof illustrate the invention without restricting the scope thereof. It will be clear to a person skilled in the art that there exist other alternatives to the embodiments described which come within the scope of the invention. In this regard a certain number of remarks are made below. There exist many means for implementing the functions by means of hardware or software means. In this regard, the drawings are highly schematic and illustrate only one particular embodiment of the invention. Likewise, although the drawings show the various functions described by the various distinct units, this does not preclude a single hardware or software element fulfilling several functions, nor the same function being fulfilled by a set of hardware or software components or both.

Any indication of a reference to a drawing in a claim does not restrict the scope of said claim. The use of the verb “comprise” or “comprises” and conjugations thereof does not exclude the presence of elements or steps other than those indicated in a claim. The article “a” or “one” preceding an element or step does not exclude the presence of several elements or steps.

1. A device for receiving an analog signal having a spectrum situated in a given frequency band higher than a reference band centered around zero, referred to as the baseband, the device comprising:
reception means which manage at least one narrow-band noise signal located around a given noise frequency, comprising a plurality of parallel baseband conversion means defining a plurality of reception channels for converting the spectrum of the signal received into reception bands close to the baseband and shifted relative to one another so that, on each reception band, the narrow-band noise signal is superimposed on the shifted spectrum of the signal received at distinct points relative to said spectrum, and
recombination means for constructing, from the many shifted spectra of the received signal on each reception channel, a single spectrum corresponding to the spectrum of the received signal with the effect of the narrow-band noise removed and situated in a frequency band close to the baseband.

2. A device as claimed in claim 1, in which the baseband conversion means are designed to shift the spectrum of the received signal symmetrically with respect to the zero frequency.

3. A device as claimed in claim 1, in which the reception means manage a single narrow-band noise signal located around a given noise frequency and comprise, on a first reception channel, first baseband conversion means for converting the spectrum of the received signal in a first reception band close to the baseband centered around a first reception frequency and on a second reception channel, second baseband conversion means for converting the spectrum of the received signal in a second reception band close to the baseband centered around a second reception frequency and shifted with respect to the first reception band by a frequency interval equal to the difference between said first and second reception frequencies, and in which the recombination means comprise:
on one of the two channels, filtering means for filtering the received signal in a first frequency band around the noise frequency,
on the other channel, shifting means for shifting the spectrum of the received signal by said difference between the first and second reception frequencies, and filtering means for filtering the received signal outside a second frequency band centered around said noise frequency,
addition means for adding the signals coming from said first and second reception channels.

4. A device as claimed in claim 2, in which the reception means comprise, on a first reception channel, first baseband conversion means for converting the spectrum of the received signal and a first reception band close to the baseband centered around a first reception frequency shifted with respect to said noise frequency by a predefined positive difference and on a second reception channel, second baseband conversion means for converting the spectrum of the received signal in a second reception band close to the baseband centered around a second reception frequency shifted with respect to said noise frequency by a predefined negative difference equal in absolute value to said predefined positive difference, and in which the recombination means comprise:
on the first channel, first filtering means for filtering the received signal in a first frequency band around the noise frequency and shifting means for shifting the spectrum of the filtered signal by said predefined negative difference,
on the second channel, second filtering means for filtering the received signal in a second frequency band around the noise frequency and shifting means for shifting the spectrum of the filtered signal by said predefined positive difference,
addition means for adding the signals coming from said first and second reception channels.

5. A digital television receiver comprising a device as claimed in claim 1.

6. A multimedia receiver comprising a device as claimed in claim 1.

7. A transmission system comprising at least one emitter intended to emit electrical signals, a transmission network for transmitting said signals, and a receiver as claimed in claim 5 for receiving said signals.

8. A reception method for receiving an analog signal having a spectrum situated in a given frequency band higher than a reference band centered around zero, referred to as the baseband, the method comprising:
a reception step which manages at least one narrow-band noise signal located around a given noise frequency, comprising a plurality of baseband conversion steps performed in parallel defining a plurality of reception channels for converting the spectrum of the received signal in reception bands close to the baseband and shifted with respect to one another so that, on each reception band, the narrow-band noise signal is superimposed on the shifted spectrum of the received signal at distinct points relative to said spectrum, and
a recombination step for reconstructing, from the many shifted spectra of the received signal on each reception channel, a single spectrum corresponding to the spectrum of the received signal with the effect of the narrow-band noise removed and situated in a frequency band close to the baseband.

9. A reception method as claimed in claim 7, in which the parallel baseband conversion steps are designed to shift the spectrum of the received signal symmetrically with respect to said given noise frequency.

10. A program containing instructions for implementing a reception method as claimed in claim 7 when it is executed by a processor.
